(19) United States
(12) Patent Application Publication
(10) Pub. No.: US 2022/0055442 A1
(43) Pub. Date: Feb. 24, 2022

(54) ONLINE CAPACITY ESTIMATION OF A REGRIGERATION UNIT

(71) Applicant: CARRIER CORPORATION, Palm Beach Gardens, FL (US)

(72) Inventors: Aryn Shapiro, Liverpool, NY (US); Tony Lu, Manlius, NY (US); Wei Wu, Manlius, NY (US)

(21) Appl. No.: 16/973,103

(22) PCT Filed: May 7, 2020
(86) PCT No.: PCT/US2020/031789

§ 371 Date: Dec. 8, 2020

Related U.S. Application Data
(60) Provisional application No. 62/846,315, filed on May 10, 2019.

(51) Int. Cl. B60H 1/00; B60H 1/32

(52) U.S. Cl. CPC B60H 1/0073; B60H 2001/3257; B60H 2001/325; B60H 1/3232

(57) ABSTRACT

Provided is a system and a method for estimating capacity. The system includes one or more sensors, a compressor coupled to one or more sensors, and a controller. The controller is configured to receive one or more parameters of a cooling system, receive system state information and one or more measurements from the cooling system (306, 308), and compute a cooling capacity (304) based at least in part on the one or more parameters, one or more measurements and system state information. The system is also configured to estimate cooling capacity based on one or more computed capacity over a period of time (310), and provide the estimated capacity of the cooling system to a device in real-time.

### BACKGROUND

The subject matter disclosed herein relates generally to refrigeration units, and more particularly to an online capacity estimation of a refrigeration unit.

Transport refrigeration units are used to cool cargo in a trailer or cargo compartment. The transport refrigeration units can include various systems to provide the air conditioning within the system. The cooling needs of the transport refrigeration unit may be different for the types of goods be transported. For example, dry goods may have a different setpoint than perishable goods. In addition, other factors such as the duration of the trip may impact the setpoints determined for transporting the good. There may be a need to optimize the efficiency of the refrigeration system during transport.

### BRIEF DESCRIPTION

According to an embodiment, a system for estimating capacity is provided. The system includes one or more sensors, a compressor coupled to one or more sensors, and a controller. The controller is configured to receive one or more parameters of a cooling system, receive system state information and one or more measurements from the cooling system, and compute a cooling capacity based at least in part on the one or more parameters, one or more measurements and system state information. The controller is also configured to estimate cooling capacity based on one or more computed capacity over a period of time, and provide the estimated capacity of the cooling system to a device in real-time.

In addition to one or more of the features described herein, or as an alternative, further embodiments include one or more sensors including temperature sensors, pressure sensors, or mass flow rate sensors.

In addition to one or more of the features described herein, or as an alternative, further embodiments include one or more measurements for inlet and outlet temperature measurements at the compressor of the cooling system.

In addition to one or more of the features described herein, or as an alternative, further embodiments include one or more measurements for inlet and outlet pressure measurements at the compressor the cooling system.

In addition to one or more of the features described herein, or as an alternative, further embodiments include one or more parameters of the cooling system for a subcooling function of a refrigerant used in the cooling system.

In addition to one or more of the features described herein, or as an alternative, further embodiments include a subcooling function that is based at least in part on outside air temperature and a valve position of valve of the cooling system.

In addition to one or more of the features described herein, or as an alternative, further embodiments include a controller that is configured to average the one or more computed capacities over a period of time.

In addition to one or more of the features described herein, or as an alternative, further embodiments include a controller that is configured to perform calibration of the average computed cooling capacity.

In addition to one or more of the features described herein, or as an alternative, further embodiments include a controller that is configured to determine calibration estimations for known valve positions and outside air temperatures (OAT) from simulation or experimentation.

In addition to one or more of the features described herein, or as an alternative, further embodiments include a subcooling function that is estimated based at least in part on the OAT and valve position.

According to an embodiment, a method for estimating capacity of a cooling system is provided. The method includes receiving one or more parameters of a cooling system, receiving system state information and one or more measurements from the cooling system, and computing cooling capacity based at least in part on the one or more parameters, one or more measurements and system state information. The method also includes estimating cooling capacity based on one or more computed capacities over a period of time, and provide the estimated cooling capacity of the cooling system to a device in real-time.

In addition to one or more of the features described herein, or as an alternative, further embodiments include one or more sensors including temperature sensors, pressure sensors, or mass flow rate sensors.

In addition to one or more of the features described herein, or as an alternative, further embodiments include one or more measurements for inlet and outlet temperature measurements at the compressor of the cooling system.

In addition to one or more of the features described herein, or as an alternative, further embodiments include one or more measurements for inlet and outlet pressure measurements at the compressor the cooling system.

In addition to one or more of the features described herein, or as an alternative, further embodiments include one or more parameters of the cooling system for a subcooling function of a refrigerant used in the cooling system.

In addition to one or more of the features described herein, or as an alternative, further embodiments include a subcooling function that is based at least in part on outside air temperature and a valve position of valve of the cooling system.

In addition to one or more of the features described herein, or as an alternative, further embodiments include averaging the one or more computed capacities over a period of time.

In addition to one or more of the features described herein, or as an alternative, further embodiments include performing calibration of the average computed cooling capacity.

In addition to one or more of the features described herein, or as an alternative, further embodiments include determining calibration estimations for known valve positions and outside air temperatures (OAT) from simulation or experimentation.

In addition to one or more of the features described herein, or as an alternative, further embodiments include estimating the subcooling function based at least in part on the OAT and valve position.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features and advantages of embodiments are apparent from the following detailed description taken in conjunction with the accompanying drawings in which:

FIG. 1 depicts a system having a transport refrigeration unit and a cargo compartment in an exemplary embodiment;

FIG. 2 depicts a transport refrigeration unit for a cargo compartment of the system of FIG. 1 in an exemplary embodiment;

FIG. 3 depicts a flowchart of a method for estimating a cooling capacity of a cooling in accordance with one or more embodiments; and

FIG. 4 depicts another flowchart of a method for estimating a cooling capacity of a cooling in accordance with one or more embodiments.

### DETAILED DESCRIPTION

The techniques described herein provide the capability for performing an online cooling capacity estimation for a refrigeration unit. The cooling capacity indicates the refrigeration unit's ability to remove heat from a given space. The cooling load provides the amount of heat energy needed to be removed from a given space to maintain the temperature within an acceptable range. The cooling capacity estimation can be used for both system control and system diagnostics to determine how efficiently the load is being managed.

Various types of goods can require different cooling temperature needs to ensure the integrity of the goods during transport. The harm caused to the goods can be increased based on the length of the trip, ambient temperature, efficiency of the system, and other factors. For example, perishable food items may be able to withstand warmer temperatures for a short trip. However, if the duration of the trip is long enough, the perishable items may not be able to withstand the damage caused by inadequate cooling.

Although the temperature setpoint can simply be changed to a higher or lower temperature setpoint, without knowing the load, the appropriate setpoint may not be able to be determined. That is, an operator may not know exactly how much higher or lower to adjust the setpoint without knowing the load.

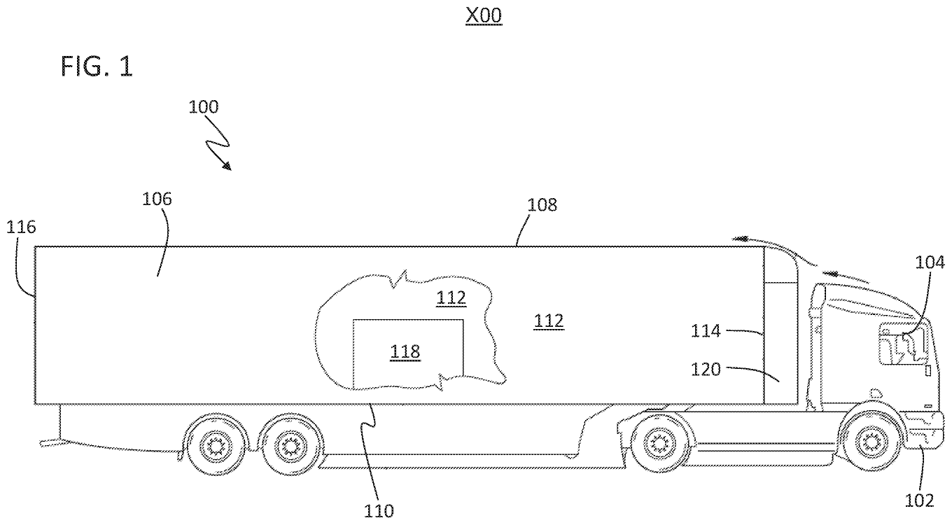

Shown in FIG. 1 is an embodiment of a tractor trailer system 100. Although a cargo compartment for a tractor trailer system is shown in FIG. 1, the cargo compartment can be used in any type of vehicle used for transporting goods including aircraft and ships. The tractor trailer system 100 includes a tractor 102 including an operator's compartment or cab 104 and also including an engine, which acts as the drive system of the tractor trailer system 100. A trailer 106 is coupled to the tractor 102. The trailer 106 is a refrigerated trailer 106 and includes a top wall 108, a directly opposed bottom wall 110, opposed side walls 112, and a front wall 114, with the front wall 114 being closest to the tractor 102. The trailer 106 further includes a door or doors (not shown) at a rear wall 116, opposite the front wall 114. The walls of the trailer 106 define a cargo compartment. The trailer 106 is configured to maintain a cargo 118 located inside the cargo compartment at a selected temperature through the use of a transport refrigeration unit 120 located on the trailer 106. The transport refrigeration unit 120, as shown in FIG. 1, is located at or attached to the front wall 114.

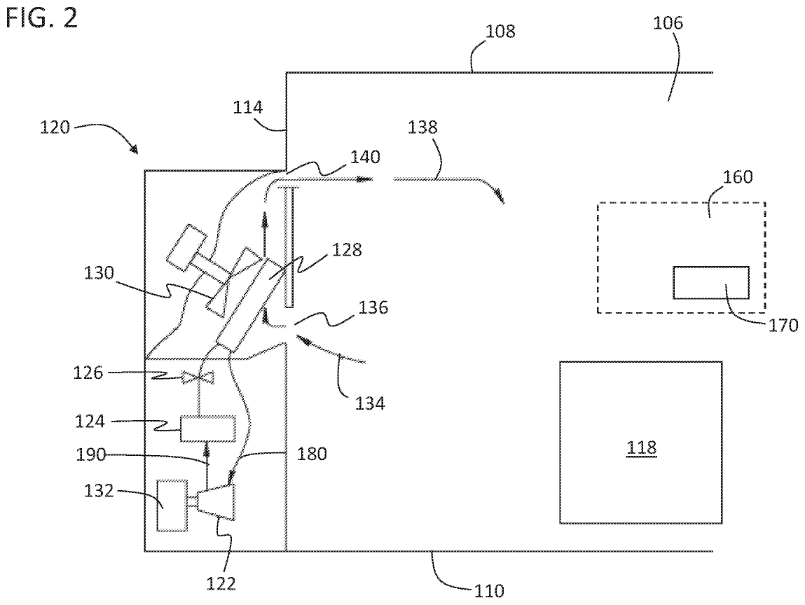

Referring now to FIG. 2, the transport refrigeration unit 120 is shown in more detail. The transport refrigeration unit 120 includes a compressor 122, a condenser 124, an expansion valve 126, an evaporator 128, and an evaporator fan 130. The compressor 122 is operably connected to a AC power source 132 which drives the compressor 122. Airflow is circulated into and through the cargo compartment of the trailer 106 by means of the transport refrigeration unit 120. A return airflow 134 flows into the transport refrigeration unit 120 from the cargo compartment of the trailer 106 through a refrigeration unit inlet 136, and across the evaporator 128 via the evaporator fan 130, thus cooling the return airflow 134. The cooled return airflow 134, now referred to as supply airflow 138, is supplied into the cargo compartment of the trailer 106 through a refrigeration unit outlet 140, which in some embodiments is located near the top wall 108 of the trailer 106. The supply airflow 138 cools the cargo 118 in the cargo compartment of the trailer 106. A controller 160 controls various aspects of the transport refrigeration unit 120 and the transport refrigeration unit power system. The controller 160 can control the compressor 122, the condenser 124, condenser fan (not shown), the expansion valve 126, the evaporator 128, and the evaporator fan 130 in addiction to other equipment or sensors. The controller 160 can be connected to the equipment over a wired or wireless connection (connections not shown). The controller 160 also includes a cooling capacity computation module 170 which is used to perform various estimations and calculations of the refrigeration system of the transport refrigeration unit 120 to determine a state of operation. The cooling capacity can be determined using sensors such as the inlet, outlet pressure/temperature using sensors 180, 190.

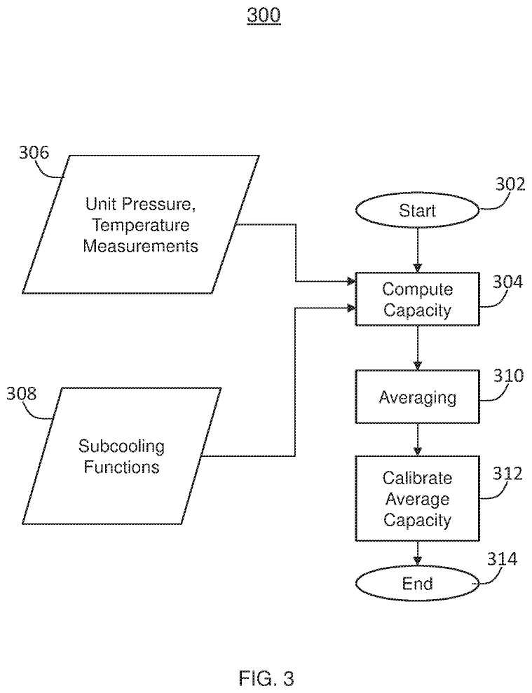

FIG. 3 depicts a high-level flowchart of a method 300 for performing real-time online capacity estimation of a refrigeration system. The method 300 begins at block 302 and proceeds to block 304 to compute cooling capacity for the cooling system. The unit pressure/temperature measurements are obtained at block 306 and the subcooling function for a refrigerant in the cooling system is obtained at block 308. The data is provided to block 304 to compute the cooling capacity. In one or more embodiments, the cooling capacity can be determined based on the following Equation:

CoolingCap_Ref=DUV*Flow Rate*(hout_evap−hin_evap)*Calibration Factor;

where DUV−digital valve; flow rate−mass flow rate at the compressor; hout_evap is a function of outlet temperature and pressure; hin_evap is a function of inlet temperature and pressure; calibration factor accounts for a margin of error that may be introduced in the computation.

In some embodiments, the pressure and temperature measurements can be obtained and using interpolation the mass flow rate can be calculated using some assumptions using prior data (subcooling temperature and real-time measurements). In addition, because system models and assumptions are used during the estimation some errors may have been introduced into the computation. A calibration factor can be used to compensate for deviations in the calculations.

At block 310, the computed capacities can be averaged over a period of time. In one or more embodiments, the averaged computed capacities can be calibrated to remove error from the result at block 312 to estimate the cooling capacity of the system. The method 300 ends at block 314.

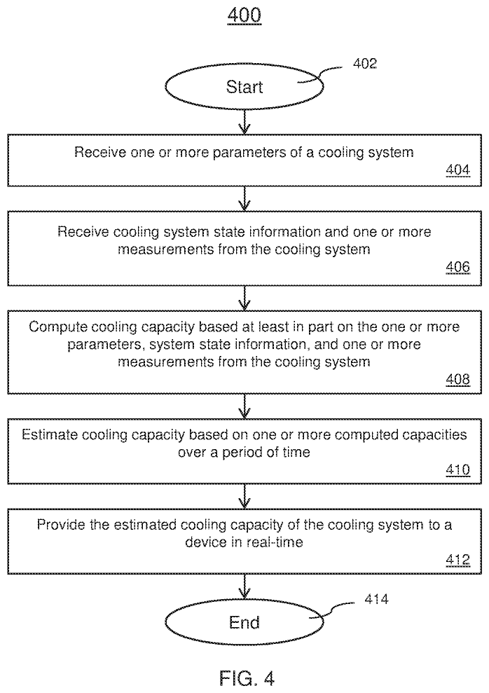

Now referring to FIG. 4, another flowchart of a method 400 for estimating cooling capacity is shown. The method 400 starts at block 402 and proceeds to block 404 which provides for receiving one or more parameters of a cooling system. In one or more embodiments the one or more parameters can include a subcooling function or a calibration factor that has been determined from experimentation or simulation.

The block 406 the method 400 provides for receiving system state information and one or more measurements from the cooling system. The one or more measurements can include the temperature and pressure measurements that are taken at various points in the cooling system. The measurements can be taken at the inlet and outlet of the compressor and used for calculating and estimating various information of the cooling system. That is, the suction and discharge temperatures and pressures are measured. In addition, the effective position of the valve can be determined from the system to control the flow rate of the refrigerant in the cooling system.

At block 408, the method 400 provides for computing cooling capacity based at least in part on the one or more parameters, the system state information, and the one or more measurements. In one or more embodiments, the capacity is estimated by averaging the computed capacity over a duty cycle associated with the effective state of a valve which is proportional to the flow rate of the cooling refrigerant in the cooling system. The average is taken over the duty cycle (PWM period) to estimate the capacity and improve accuracy by reducing the capacity variation that occurs over the PWM period. It should be understood, the techniques described herein can be applied to systems that do not use PWM, such as those systems that use steppers or variable-frequency drives (VFDs). In this scenario, the averaging step may be unnecessary.

The 400 at block 410 provides estimating a cooling capacity based on one or more computed capacities over a period of time and the estimated cooling capacity can be provided at shown in block 412 as an input to one or more devices used by an operator or administrator to monitor the cooling system. In other embodiments, the estimated capacity can be provided to other systems that can leverage the estimated capacity to perform load estimations, implement enhanced cargo area control, perform diagnostics, cargo profiling and more. The method 400 ends at block 414. It should be understood that the capacity estimation for the cooling system is not limited by the steps provided in FIG. 4 and different steps and sequence of steps can be performed to determine the capacity of the system.

Various methodologies can be used to perform a cross-check or validation of the capacity determined by the different methodologies. That is, the different techniques to devise system state estimations can be correlated to determine both accuracy and also for diagnostic purposes. One of the techniques described herein provides a capacity estimation that involves the user of refrigerant sensors and system state information, but the scope is not intended to be limited by this embodiment. Online estimation of cooling capacity can be used for load estimation, enhanced cargo area control, diagnostics, cost reduction, cargo profiling, and others.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A system for estimating capacity, the system comprising;
one or more sensors;
compressor coupled to one or more sensors;
a controller configured to:
receive one or more parameters of a cooling system;
receive system state information and one or more measurements from the cooling system;
compute a cooling capacity based at least in part on the one or more parameters, one or more measurements and system state information;
estimate cooling capacity based on one or more computed capacity over a period of time; and
provide the estimated capacity of the cooling system to a device in real-time.

2. The system of claim 1, wherein the one or more sensors comprise temperature sensors, pressure sensors, or mass flow rate sensors.

3. The system of claim 1, wherein the one or more measurements comprise inlet and outlet temperature measurements at the compressor of the cooling system.

4. The system of claim 1, wherein the one or more measurements comprise inlet and outlet pressure measurements at the compressor the cooling system.

5. The system of claim 1, wherein the one or more parameters of the cooling system comprises a subcooling function of a refrigerant used in the cooling system.

6. The system of claim 5, wherein the subcooling function is based at least in part on outside air temperature and a valve position of valve of the cooling system.

7. The system of claim 6, wherein the controller is configured to average the one or more computed capacities over a period of time.

8. The system of claim 7, wherein the controller is configured to perform calibration of the average computed cooling capacity.

9. The system of claim 8, wherein the controller is configured to determine calibration estimations for known valve positions and outside air temperatures (OAT) from simulation or experimentation.

10. The system of claim 9, wherein the subcooling function is estimated based at least in part on the OAT and valve position.

11. A method for estimating capacity of a cooling system, the method comprising:
receiving one or more parameters of a cooling system;
receiving system state information and one or more measurements from the cooling system;
computing cooling capacity based at least in part on the one or more parameters, one or more measurements and system state information;
estimating cooling capacity based on one or more computed capacities over a period of time; and
provide the estimated cooling capacity of the cooling system to a device in real-time.

12. The method of claim 11, wherein the one or more sensors comprise temperature sensors, pressure sensors, or mass flow rate sensors.

13. The method of claim 11, wherein the one or more measurements comprise inlet and outlet temperature measurements at the compressor of the cooling system.

14. The method of claim 11, wherein the one or more measurements comprise inlet and outlet pressure measurements at the compressor the cooling system.

15. The method of claim 11, wherein the one or more parameters of the cooling system comprises a subcooling function of a refrigerant used in the cooling system.

16. The method of claim 15, wherein the subcooling function is based at least in part on outside air temperature and a valve position of valve of the cooling system.

17. The method of claim 16, further comprising averaging the one or more computed capacities over a period of time.

18. The method of claim 17, further comprising performing calibration of the average computed cooling capacity.

19. The method of claim 18, further comprising determining calibration estimations for known valve positions and outside air temperatures (OAT) from simulation or experimentation.

20. The method of claim 19, further comprising estimating the subcooling function based at least in part on the OAT and valve position.
